(19) United States
(12) Patent Application Publication
(10) Pub. No.: US 2006/0242568 A1
(43) Pub. Date: Oct. 26, 2006

(54) Document image signature identification systems and methods

(75) Inventor: Michael A. Gatto, Macedon, NY (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: Xerox Corporation

(21) Appl. No.: 11/114,709

(22) Filed: Apr. 26, 2005

(51) Int. Cl. G06F 17/00

(52) U.S. Cl. 715/517

(57) ABSTRACT

Method and system embodiments create unique signatures based on the unique layouts of user-readable text and graphics on a variable information document. The embodiments create, or are supplied with, a variable information document comprising a storyline of user-readable text and graphics and use a heuristic to create the unique signature for the variable information document, without adding markings to the variable information document. The unique arrangement of at least a portion of the user-readable text and graphics actually comprises the unique signature of the variable information document. The method prints the text and graphics in the unique arrangement as a printed document and can later scan at least a portion of the printed document to identify the unique signature.

### BACKGROUND

Embodiments herein generally relate to identifiers or unique signatures that are included within printed documents and more particularly to a method and system that creates unique signatures based on unique layouts of user-readable text and graphics on the printed document.

Conventional systems create additional markings, such as bar codes and other computer readable marks, in order to identify printed documents. For example, as described in U.S. Patent Publication 2005/0023355, incorporated herein by reference, barcodes have been used for many years in commercial settings. Barcodes are printed on many different types of media and represent information in encoded form. Once printed, these barcodes may be scanned using a barcode scanner, which reads the barcode to decode the information encoded therein.

For example, as described in U.S. Patent Publication 2004/0156064, incorporated herein by reference, a cover sheet is used that contains information identifying the pages of a multi-page print job present in a particular set. The information can be in human-readable form, as well as machine-readable form (such as by bar code) which is generated by the print-engine controller which controls the printing of the sets.

With respect to variable data or variable information documents in general, documents created in electronic form are often represented in a page description language (“PDL”), such as PostScript, PCL, AgfaScript and IPDS. In a PDL representation, a document may be described in terms of commands that represent text and graphical objects. Data commands describe the data that must be reproduced by the output device, such as text, graphics and images, whereas control commands describe how the data must be reproduced, and may include font descriptions, page sections, forms and overlays. Each independent data stream segment includes data commands to describe the images included in a single page or region (i.e., a disjunctive portion of a physical medium), and also includes control commands to instruct how the data commands must be interpreted.

To view or print the document, the PDL commands are sent to a raster image processor (“RIP”), which interprets the PDL commands and generates electronic signals used by an output device to render the text and graphical objects. For example, the RIP may be part of a personal computer or workstation, and the output device may be a video display screen. Alternatively, the RIP may be part of a printer controller, and the output device may be a print engine. In either case, the RIP converts the PDL print stream to a raster bitmap.

Variable information print jobs are typically made of a print stream and associated resource files, such as TIFF files, PostScript segments, etc. There are multiple types of variable information print streams, such as personalized print markup language (PPML) or variable intelligent personalized PostScript (VIPP). To easily facilitate moving the print files and their associated resource files, the print files and resource files are often packaged in zip files or VIPP container files.

Thus, variable information documents can include instructions to add a unique marker to the document to allow the documents to be identified and controlled. While these conventional markings can be designed to be mostly imperceptible to the user, or be located in regions of the document so that they reader would not normally see them, at certain times, such markings are apparent to the user and therefore degrade the quality of the printed product.

### SUMMARY

A method embodiment herein creates signatures for variable information documents based on unique layouts of user-readable text and graphics on the printed document, using any heuristic. The method embodiment creates or is supplied with a variable information document comprising a storyline of user-readable text and graphics. The text and graphics are laid out in a unique arrangement. The laying out of the text and graphics can comprise an automated and/or manual process and can be performed by a third party program or can be performed by embodiments herein. All or a portion of this unique arrangement of user-readable text and graphics actually comprises the unique signature of the variable information document. The method scans at least a portion of the printed document to identify the unique signature of the printed document.

This unique arrangement comprises a unique relative position of the text and graphics on at a least a portion of the printed document. Again, the text and graphics comprise user readable content of the printed document. In other words, the unique signature is not contained in hidden markings, bar codes, etc., but instead comprises the unique arrangement of the text and graphics of the storyline created by the user as intended to be read by a human reader.

For purposes herein, the unique arrangement of the text and graphics of one document will be made different than arrangements of text and graphics of other variable information documents. Further, the embodiments herein may only look to a limited area of the entire document (which may be multiple pages, or only a portion of one page) for the unique signature area.

In one embodiment, the method can change the unique arrangement of the text and graphics to (or be supplied with) a second unique arrangement of the text and graphics to create a second unique signature and then reprint the printed document using the second unique arrangement of the text and graphics as a second printed document. This change may be so slight as to be nearly imperceptible to the user, yet distinct enough to distinguish one signature from another. Thus, this second unique signature of the second printed document comprises a machine-identifiable unique signature different than the unique signature of the first printed document. After identifying the unique signature, any additional finishing processing steps (folding, stapling, binding, etc.) that are associated with the variable information document can be identified, and the printed document can be finished according to the additional processing steps.

A system embodiment is also provided to create unique signatures for variable information documents based on unique layouts of user-readable text and graphics on the printed document, using any heuristic. The system embodiment comprises, or can be used with, a software program that creates the variable information document. A signature module, that operates using any heuristic, is operatively connected to the software program. The signature model is adapted to create the signature based on the layout of text and graphics, using any heuristic. Also, a printing engine is operatively connected to the signature module, and is used to print the unique arrangement of the text and graphics as the printed document. A scanner can be used to scan at least a portion of the printed document to later identify the unique signature.

In one embodiment, the signature module can be used to change the unique arrangement of the text and graphics to (or be supplied with) a second unique arrangement of text and graphics to create a second unique signature for an otherwise identical document. Then, the printing engine can reprint the document using the second unique arrangement of the text and graphics as a second printed document. Thus, when the scanner scans the second printed document, it will identify the second unique signature of the second printed document as a unique signature different than the unique signature of the original printed document. Further, the signature module can be adapted to lay out the text and graphics automatically and/or with user input.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flowchart illustrating a method embodiment;

FIG. 2 is a schematic representation of a system embodiment;

FIG. 3 is a schematic representation of a heuristic applied to an image;

FIG. 4 is a schematic representation of a printed document;

FIG. 5 is a schematic representation of a printed document

FIG. 6 is a schematic representation of a printed document; and

FIG. 7 is a schematic representation of a printed document.

### DETAILED DESCRIPTION

As mentioned above, while conventional added document signature markings can be designed to be mostly imperceptible to the user, or be located in regions of the document so that they reader would not normally see them, at certain times, such added markings are apparent to the user and therefore degrade the quality of the printed product. The embodiments described herein address this problem by providing a method and system that avoid adding any markings to the variable information document. Rather than adding markings such as bar codes, etc., the embodiments herein create a unique document signature based on the arrangement of the text and graphic elements of the variable information document, using any heuristic. Thus, with embodiments herein, the unique pattern or layout arrangement of the text and graphics is the signature for the document.

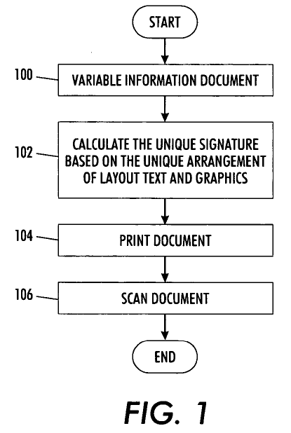

As shown in flowchart form in FIG. 1, a method embodiment herein creates unique identifiers or “signatures” based on the unique layouts of user-readable, user-created text and graphics on the printed variable information document, using any heuristic. In item 100, the method embodiment creates or is supplied with a variable information document comprising a “storyline” of user-readable, user-created text and graphics.

The “storyline” of a document is a message intended to be transmitted to the reader. Therefore, in a document containing text, the words transfer a story or message to the reader. Graphics including pictures, graphs, charts, and any other type of non-textural material can help convey the story to the reader. Similarly, documents that are mostly, or completely, data similarly can be a story or message of data to the user. The storyline that is conveyed to the user is distinguished from the signature or identification data that is conveyed to a machine because the signature information is intended to be only machine-readable (with minor exceptions for certain individuals with special knowledge or abilities). One feature of the embodiments herein is that no visible machine-readable marks are added to the text and graphics that make up the storyline. Instead, with embodiments herein, subtle differences of the arrangement of the text and graphics on the printed sheet make up the machine-readable identification information. Therefore, most individuals will not recognize that that document identifier or signature is included within the document.

The method calculates the unique signature in item 102. More specifically, the embodiments herein select all or a portion of the document that includes text and graphics, and apply a heuristic to that area to produce some form of code that is used as the signature. The heuristic can be of any form. For example, a key can be used to score certain items of text and graphics.

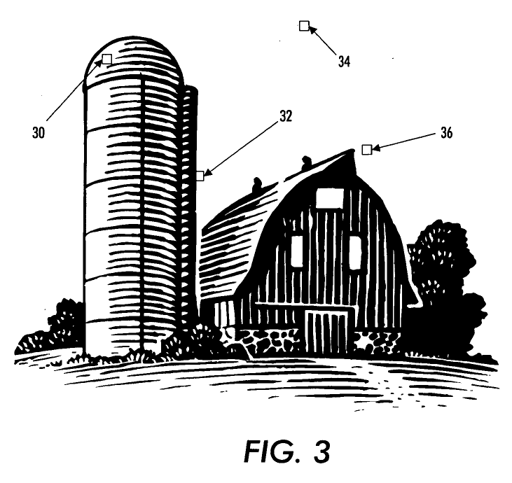

One example of such a key can apply a specific count or value to certain pixels at specific two-dimensional locations on the area of the document being evaluated. One very simplified example of a document signature heuristic comprising a code of pixel values of different two-dimensional locations is shown in FIG. 3. More specifically, the two-dimensional (X,Y) locations 30, 32, 34, and 36 each receive a numerical score depending upon brightness, color, shading, etc. If each location were given a single digit number score, the locations could score as follows: location 30=5; location 32=7; location 34=0; and location 36=3. This could result in a code 5703 if the value of each location is simply stated sequentially within the code. One ordinarily skilled in the art would understand that the foregoing heuristic is only one example of an unlimited number of different heuristics that could be utilized with embodiments herein. For example, the different heuristic could be based upon a word count, word pattern, a combination of an image and text pattern, text or image sizes, etc.

The text and graphics (item 104) are therefore printed in a unique arrangement as a printed document. This printed document can later be scanned (item 106) and at least a portion of the printed document can be examined to identify the unique signature. This unique arrangement comprises a unique relative position of the text and graphics on the printed document. Again, the text and graphics comprise user readable content of the printed document. In other words, the unique signature is not contained in hidden markings, bar codes, etc., but instead comprises the unique arrangement of the text and graphics of the storyline created by the user as intended to be read by a human reader.

As suggested above, it is sometimes desirable to process different numbers of copies of an identical document in different ways. For example, a user may want to have one set of copies of a document simply stapled and another set of copies of the document bound using more expensive binding material. Therefore, while the different sets of copies of the document use identical text and graphics, the two different sets of copies can have different document signatures so that they can be handled differently by the finisher units. With embodiments herein, the unique arrangement of the text and graphics for one document signature can be (automatically and/or manually) made different than arrangements of text and graphics of other variable information documents, even if the exact same text and graphics are used. Therefore, the method can identify a second document signature after one unique arrangement of the text and graphics is changed to a second unique arrangement of the text and graphics (item 102) and then reprint (item 104) the printed document using the second unique arrangement of the text and graphics as a second printed document. The second unique signature of the second printed document also comprises a machine-identifiable unique signature that is different than the unique signature of the original printed document. After identifying the unique signature, any additional finishing processing steps (folding, stapling, binding, etc.) that are associated with the variable information document are identified, and the printed document is finished according to the additional processing steps.

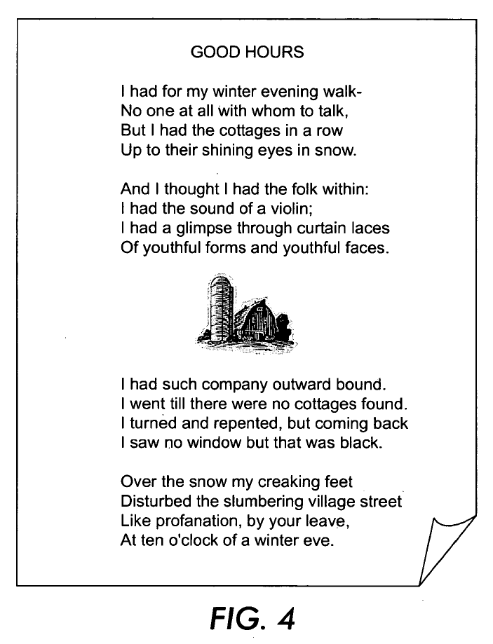

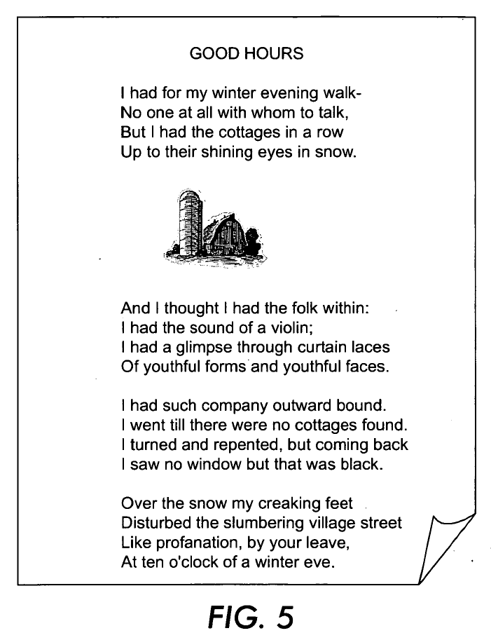

The laying out of the text and graphics can comprise an automated and/or manual process. Embodiments herein can utilize any type of methodology to lay out the text and graphics in a unique manner. In one embodiment, the method can automatically (without user input) change the unique arrangement of the text and graphics to a second unique arrangement of the text and graphics to create a second unique signature and then reprint the printed document using the second unique arrangement of the text and graphics as a second printed document (e.g., see FIGS. 4 and 5 for example). This change may be so slight as to be nearly imperceptible to the user, yet distinct enough to distinguish one signature from another. Thus, this second unique signature of the second printed document comprises a machine-identifiable unique signature different than the unique signature of the first printed document.

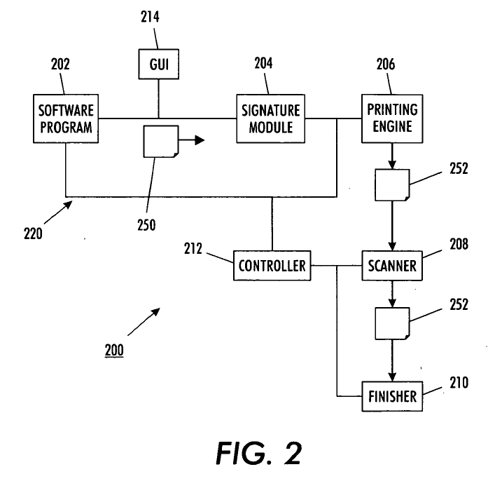

As shown in FIG. 2, a system embodiment 200 is also provided to create unique signatures based on unique layouts of user-readable and user-supplied text and graphics on the printed document. The system embodiment comprises, or can be used with, a software program 202 that creates the variable information document 250 from user input obtained through a graphic user interface (GUI) 214. As discussed in the background section above, almost any type of software program can be configured to create variable data or variable information documents and the embodiments herein are not limited to any particular type of software program. Instead, the embodiments herein are intended to work with all available software programs whether currently marketed or developed in the future. Similarly, the graphic user interface 214 can comprise any commercially available user interface whether currently available or developed in the future.

A signature module 204 is operatively connected to the software program 202, through, for example, a wired or wireless network (or internal wiring, if all elements shown in FIG. 2 are included within a single device) 220. The signature module 204 can comprise a software program or a hardware device that includes programmed or programmable hardware features. As would be understood by one ordinarily skilled in the art, the signature module 204 can include processors, memory units, input/output ports, etc. The signature model 204 is adapted to lay out the text and graphics from the variable information document 250 that are to be printed in the unique arrangement that comprises the unique signature of the variable information document.

Also, a printing engine 206 is operatively connected to the signature module 204, and is used to print the unique arrangement of the text and graphics as the printed document 252. The printing engine 206 can comprise any type of printer, including xerographic, laser, inkjet, dot matrix, etc., whether currently known or developed in the future. A scanner 208 can be used to scan at least a portion of the printed document 252 to identify the unique signature. Again, the scanner 208 can comprise any currently available scanner, or any scanner developed in the future. Item 210 comprises a finisher unit which is adapted to perform any commonly known finishing function on the printed document 252. See, generally, U.S. Patent Publication 2004/0175255 (incorporated herein by reference) for examples of finisher devices. Further, a controller 212 can be used for other logical functions including storing the unique signatures, comparing scanned documents with known signatures, identifying the unique signatures, controlling the printing engine 206, scanner 208, finisher 210, etc. to process the printed document as intended by the software program 202 or to follow other instructions, etc. As would be understood by one ordinarily skilled in the art, a controller 212 can comprise any form of dedicated or non-dedicated device capable of performing logic and control operations.

The signature module 204 can be used to change the unique arrangement of the text and graphics to a second unique arrangement of text and graphics to create a second unique signature. Then, the printing engine 206 can reprint the document using the second unique arrangement of the text and graphics as a second printed document. Thus, when the scanner 208 scans the second printed document, it will identify the second unique signature of the second printed document as a unique signature different than the unique signature of the original printed document. Further, the signature module 204 can be adapted to lay out the text and graphics automatically and/or with user input through the graphic user input 214.

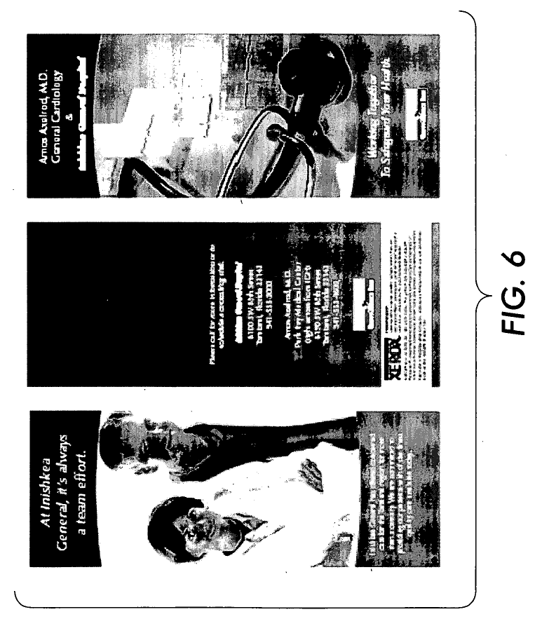

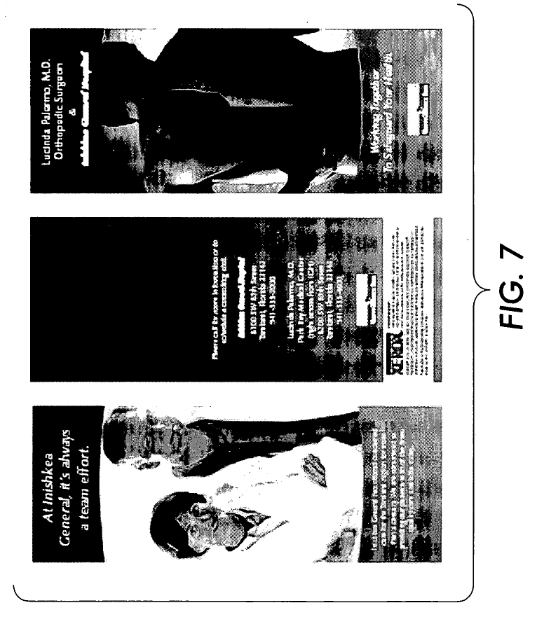

FIGS. 4 and 5 illustrate one example of different layouts that can be used by embodiments herein to provide different document signatures. In both FIGS. 4 and 5 the same text and graphic item appears. However, in FIG. 4 the graphic item appears between the second and third paragraphs, while in FIG. 5 the graphic appears between the first and second paragraphs. Similarly, FIGS. 6 and 7 illustrate another example of different layouts that can be used by embodiments herein to provide different document signatures. In both FIGS. 6 and 7 the same text and graphic item appears in the first two thirds of the document. However, in FIG. 7 the graphic item in the last third of the document is different than the last third of the document in FIG. 6.

One aspect of the embodiments herein is that the data that is used to create the document signature in all user-readable. As described in U.S. Patent Application 2004/0078333, incorporated herein by reference, a document can be printed with graphical symbols (barcodes) which encode information. The encoded information is not human readable, but is visible. For example a bar code is visible but not human readable (by most people). While conventional systems (such as U.S. Patent Application 2004/0078333) rely upon adding visible marks to encode information (including glyphs, 2D bar codes and other forms of graphical indicia) the embodiments herein avoid such additional marking, thereby increasing the quality of the final printed product.

Thus, despite conventional efforts to the contrary, at certain times, document identifier markings are apparent to the user and therefore degrade the quality of the printed product. The embodiments described herein address this problem by providing a method and system that avoids adding any markings to the variable information document. Rather than adding markings such as bar codes, etc., the embodiments herein use the unique layout arrangement of the text and graphics as the signature for the document.

It will be appreciated that the above-disclosed and other features and functions, or alternatives thereof, may be desirably combined into many other different systems or applications. Also various presently unforeseen or unanticipated alternatives, modifications, variations or improvements therein may be subsequently made by those skilled in the art which are also intended to be encompassed by the following claims.

What is claimed is:

1. A method comprising:
supplying a variable information document comprising a storyline comprising a unique arrangement of text and graphics; and
creating a unique signature for said variable information document based on at least a portion of said unique arrangement of said text and graphics in said variable information document.

2. The method according to claim 1, wherein said unique arrangement comprises a unique relative position of said text and graphics.

3. The method according to claim 1, wherein said text and graphics comprise user readable content of said printed document.

4. The method according to claim 1, wherein said unique arrangement of said text and graphics is different than arrangements of text and graphics of other variable information documents.

5. The method according to claim 1, further comprising:
changing said unique arrangement of said text and graphics to a second unique arrangement of said text and graphics; and
creating a second unique signature based on at least a portion of said second unique arrangement of said text and graphics in said variable information document,
wherein said second unique signature of said second printed document comprises a machine-identifiable unique signature different than said unique signature of said printed document.

6. A method comprising:
supplying a variable information document comprising a storyline comprising a unique arrangement of text and graphics;
creating a unique signature for said variable information document based on at least a portion of said unique arrangement of said text and graphics in said variable information document;
printing said variable information document as a printed document; and
scanning at least said portion of said printed document to identify said unique signature.

7. The method according to claim 6, wherein said unique arrangement comprises a unique relative position of said text and graphics.

8. The method according to claim 6, wherein said text and graphics comprise user readable content of said printed document.

9. The method according to claim 6, wherein said unique arrangement of said text and graphics is different than arrangements of text and graphics of other variable information documents.

10. The method according to claim 6, further comprising:
changing said unique arrangement of said text and graphics to a second unique arrangement of said text and graphics; and
creating a second unique signature based on at least a portion of said second unique arrangement of said text and graphics in said variable information document,
wherein said second unique signature of said second printed document comprises a machine-identifiable unique signature different than said unique signature of said printed document.

11. A system comprising:
a signature module adapted to receive a variable information document comprising a storyline comprising a unique arrangement of text and graphics,
wherein said signature model is adapted to create a unique signature for said variable information document based on at least a portion of said unique arrangement of said text and graphics in said variable information document.

12. The system according to claim 11, wherein said unique arrangement comprises a unique relative position of said text and graphics.

13. The system according to claim 11, wherein said text and graphics comprise user readable content of said printed document.

14. The system according to claim 11, wherein said unique arrangement of said text and graphics is different than arrangements of text and graphics of other variable information documents.

15. The system according to claim 11, wherein said signature module is further adapted to:
change said unique arrangement of said text and graphics to a second unique arrangement of said text and graphics; and
create a second unique signature based on at least a portion of said second unique arrangement of said text and graphics in said variable information document,
wherein said second unique signature of said second printed document comprises a machine-identifiable unique signature different than said unique signature of said printed document.

16. A system comprising:
a signature module adapted to receive a variable information document comprising a storyline comprising a unique arrangement of text and graphics, wherein said signature model is adapted to create a unique signature for said variable information document based on at least a portion of said unique arrangement of said text and graphics in said variable information document;
a printer adapted to print said variable information document as a printed document; and
a scanner adapted to scan at least said portion of said printed document to identify said unique signature.

17. The system according to claim 16, wherein said unique arrangement comprises a unique relative position of said text and graphics.

18. The system according to claim 16, wherein said text and graphics comprise user readable content of said printed document.

19. The system according to claim 16, wherein said unique arrangement of said text and graphics is different than arrangements of text and graphics of other variable information documents.

20. The system according to claim 16, wherein said signature module is further adapted to:
change said unique arrangement of said text and graphics to a second unique arrangement of said text and graphics; and
create a second unique signature based on at least a portion of said second unique arrangement of said text and graphics in said variable information document,
wherein said second unique signature of said second printed document comprises a machine-identifiable unique signature different than said unique signature of said printed document.
